(19) United States
(12) Patent Application Publication
(10) Pub. No.: US 2018/0066834 A1
(43) Pub. Date: Mar. 8, 2018

(54) LIGHTING FIXTURE CONNECTION ASSEMBLY

(71) Applicant: Flextronics AP, LLC, Broomfield, CO (US)

(72) Inventors: Jordon Musser, Dallas, TX (US); Ashish Anthony, Anna, TX (US)

(21) Appl. No.: 15/258,582

(22) Filed: Sep. 7, 2016

(51) Int. Cl. F21V 23/06; F21S 8/04; F21V 23/00; F21V 29/77; F21V 31/00

(52) U.S. Cl. CPC F21V 23/06; F21S 8/04; F21V 7/00; F21V 29/773; F21V 31/005; F21V 23/003

(57) ABSTRACT

A lighting fixture includes a driver, a heat sink assembly, a light generating assembly, a first connection assembly, and a first lead. The heat sink assembly is coupled to the driver and includes a base plate that defines a first through hole. The light generating assembly is secured to the base plate and includes a PCB, a plurality of LEDs, and a board cover. The PCB defines a first board hole therethrough. The plurality of LEDs are secured direction to the PCB. The board cover is positioned over the PCB and is fastened to the base plate. The first connection assembly includes a first connector that is secured directly to the PCB and that is in electrical communication with the plurality of LEDs. The first lead extends from the driver, through the first through hole, through the first board hole, and being captured by the first connector.

### BACKGROUND

### 1. Technical Field

The present disclosure relates to lighting fixtures and, more specifically, to connector assemblies for connecting driver units to driven units.

### 2. Discussion of Related Art

Lighting fixtures for high bay facilities are designed for use in buildings with high ceilings or “high bays” such as warehouses, manufacturing facilities, retail stores, or the like where the ceilings can be between 20 and 60 feet high. High bay facilities typically mount lighting fixtures at or near the ceiling. At such heights, lighting fixtures used in high bay facilities require increased illumination output compared to lighting solutions used in standard offices or homes that have ceilings between 8 and 14 feet high.

Recently, light emitting diode (LED) technology has been used in lighting fixtures for high bay facilities to generate light. LED lighting fixtures require an LED driver to be connected to one or more LEDs which produces the light. The one or more LEDs can be assembled and arranged on a printed circuit board (PCB). The LED driver is typically remote from the PCB and is connected to the PCB by one or more lead wires.

There is a continuing need for efficient and reliable connector assemblies for connecting the lead wires to the PCB.

### SUMMARY

In an aspect of the present disclosure, a lighting fixture includes a driver, a heat sink assembly, a light generating assembly, a first connection assembly, and a first lead. The heat sink assembly is coupled to the driver and includes a base plate that defines a first through hole. The light generating assembly is secured to the base plate and includes a PCB, a plurality of LEDs, and a board cover. The PCB defines a first board hole therethrough. The plurality of LEDs are secured direction to the PCB. The board cover is positioned over the PCB and is fastened to the base plate. The first connection assembly includes a first connector that is secured directly to the PCB and that is in electrical communication with the plurality of LEDs. The first lead extends from the driver, through the first through hole, through the first board hole, and being captured by the first connector.

In aspects, the first connection assembly includes a lead seal that is positioned within the first through hole to form a seal with an inner wall of the base plate defining the first through hole and an outer surface of the first lead. The lead seal may form a seal with a surface of the PCB.

In some aspects, the first through hole is aligned with the first board hole. The board cover may isolate the PCB from an environment surrounding the light generating assembly.

In certain aspects, the lighting fixture includes a top cover coupled to the heat sink. The lighting fixture may also include a driver bracket directly secured to the top cover and the driver may be directly secured to the driver bracket. The top cover may be configured to secure the lighting fixture to a mounting surface.

In particular aspects, the lighting fixture includes a reflector secured to the base plate. The light generating assembly may be at least partially disposed within the reflector.

In some aspects, the board cover is a lens. The board cover may define a cavity with the base plate. The cavity may have a pressure different from the pressure of the environment surrounding the light generating assembly.

In aspects, the lighting fixture includes a second lead and a second connection assembly. The second connection assembly includes a second connector that is secured directly to the PCB and is in electrical communication with the plurality of LEDs. The base plate may define a second through hole and the PCB may define a second board hole therethrough. The second through hole and the second board hole may be coaxially aligned with one another. The second lead may extend from the driver, through the second through hole, and through the second board hole. The second connector may capture the second lead to electrically connect the second connector to the PCB.

In certain aspects, the first and/or the second connector may permit the first and second lead, respectively, to move in a first direction and prevent the first and second lead, respectively, from moving in a second opposite direction.

In another aspect of the present disclosure, a method of assembly a lighting fixture includes passing a first lead through a first board hole in a PCB such that an exposed end portion of the first lead is captured between opposed legs of a first connector secured to the PCB, securing the PCB to a base plate of a heat sink assembly, and securing a board cover to the base plate with the PCB disposed in a cavity defined between the board cover and the base plate. The first connection being in electrical communication with one or more LEDs of the PCB.

In aspects, securing the PCB to the base plate of the heat sink assembly occurs before passing the first lead through the first board hole in the PCB. Securing the board cover to the base plate may occur before passing the first lead through the first board hole in the PCB.

In some aspects, passing the first lead through the first board hole in the PCB includes passing the first lead through a first through hole defining the base plate that is aligned with the first board hole. Passing the first lead through a first through hold defined in the base plate may include passing the first lead through a seal that is disposed within the first through hole to form a seal about an outer surface of the first lead.

In certain aspects, the method includes creating a pressure differential in the cavity relative to the environment outside of the cavity.

Further, to the extent consistent, any of the aspects described herein may be used in conjunction with any or all of the other aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is an exploded, perspective view of an exemplary lighting fixture in accordance with the present disclosure;

FIG. 2 is an enlarged cutaway view of an assembled connection assembly of the lighting fixture of FIG. 1;

FIG. 3 is a cutaway view of the connection assembly of FIG. 2 with parts separated; and

FIG. 4 is a perspective view of the connection assembly of FIG. 3 fully assembled.

### DETAILED DESCRIPTION

The present disclosure relates generally to connector assemblies for connecting a LED driver to a PCB having one or more LEDs. The connection assembly allows lead wires from the LED driver to pass through a heat sink and the PCB permitting a robust and compact installation package. The lead wires can pass through seals in a heat sink plate such that the PCB is isolated from the surrounding environment. Isolating the PCB from the surrounding environment may increase the longevity of the PCB and/or the LEDs. In addition, isolating the PCB from the surrounding environment may improve the performance of the LEDs. Further, isolating the PCB from the surrounding environment may prevent contaminants from entering the PCB cavity.

Embodiments of the present disclosure are now described in detail with reference to the drawings in which like reference numerals designate identical or corresponding elements in each of the several views. As used herein, the terms “top” and “bottom” refer to the orientation of the figures with “top” being closer to a mounting structure for the lighting fixture and “bottom” being further from the mounting structure for the lighting fixture.

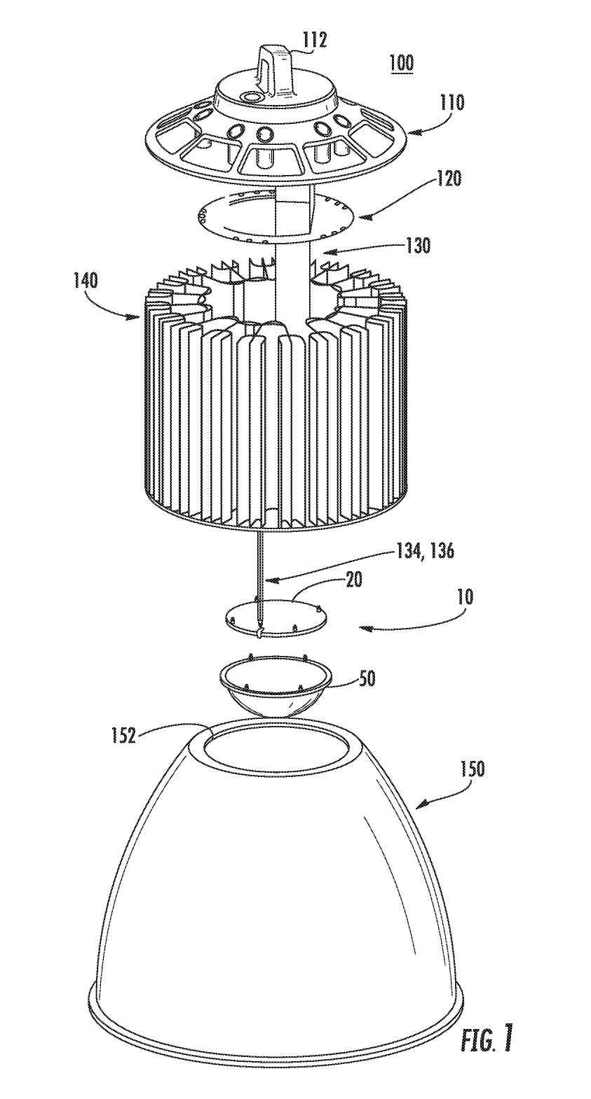

Referring now to FIG. 1, an exemplary lighting fixture 100 is provided in accordance with the present disclosure. The lighting fixture 100 includes a top cover 110, a driver bracket 120, a driver 130, a heat sink assembly 140, a light generating assembly 10, and a reflector/refractor 150. The top cover 110 secures the lighting fixture 100 to a mounting structure including, but not limited to, a ceiling, a rafter, or a catwalk. In embodiments, the top cover 110 may include a mount 112 that pivotally supports the lighting fixture 100 to the mounting structure. As shown, the top cover 110 has a frustoconical shape; however, it is contemplated that the top cover 110 may be in a variety of shapes including, but not limited to, a cube, a cuboid, a cylinder, a hexagonal prism, a pyramid, or a triangular prism cubic. For an example of a lighting fixture having a top cover of varying shapes, reference may be made to U.S. patent application Ser. No. 29/576,779, filed Sep. 7, 2016, the entire contents of which are hereby incorporated by reference.

The driver bracket 120 is secured to a top portion of the heat sink assembly 140 and supports the driver 130. It is envisioned that the driver bracket 120 may be secured between the top cover 110 and a top of the heat sink assembly 140.

The driver 130 may be an LED driver configured to convert input energy to output energy suitable for the PCB assembly. For example, the input energy may be alternating current and the output energy may be direct current. Some examples of drivers suitable for the lighting fixture 100 are available from Philips Lighting Electronics N.A. under part numbers LED-INTA-0700C-210-DO, LED-INTA-0700C-210-F-O, XH-150C070V210CNF1, and 929000702202.

The driver 130 is supported within the heat sink assembly 140 such that heat from the driver 130 is dissipated to the environment by the heat sink assembly 140. The heat sink assembly 140 can include a plurality of radiating fins configured to dissipate heat from the driver 130 and/or the light generating assembly 10. The heat sink assembly 140 may be passive, relying on environmental convection. To deliver output energy to the light generating assembly 10, a positive or first lead 134 and a negative or second lead 136 extend from the driver 130 and pass through the heat sink assembly 140 to the light generating assembly 10. It is contemplated that the lighting fixture 100 may include between 1 and about 4 drivers 130. It is also contemplated that the lighting fixture 100 may have an external driver (not shown) that provides suitable energy to light generating assemblies (e.g., light generating assembly 10) of one or multiple lighting fixtures 100.

The light generating assembly 10 includes a printed circuit board (PCB) 20 and a board cover or lens 50. The PCB 20 is coupled to a bottom portion of the heat sink assembly 140 and the lens 50 is fastened to the bottom portion of the heat sink assembly 140. The reflector/refractor 150 is coupled to the heat sink assembly 140 and is configured to direct light away from the mounting structure and/or refract light to disperse and/or diffuse light. The reflector 150 may be constructed from a variety of materials including, but not limited to, plastic, acrylic, or aluminum.

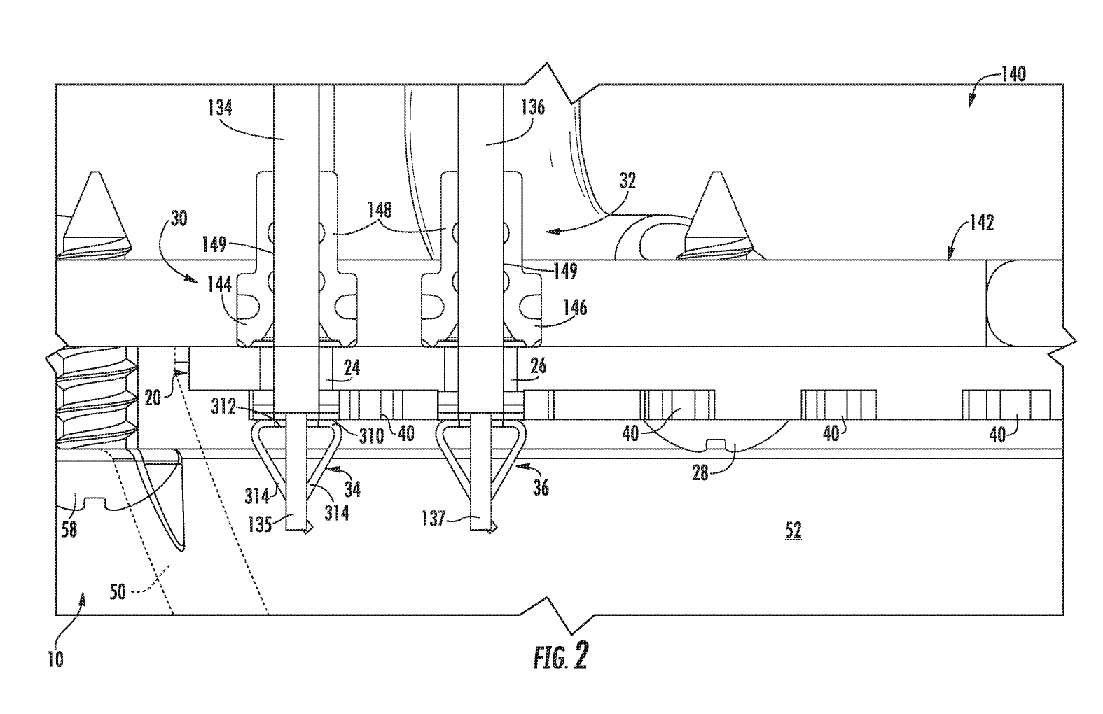

Referring now to FIG. 2 illustrating a portion of the light generating assembly 10, the heat sink assembly 140, and connector assemblies 30, 32. The PCB 20 of the light generating assembly 10 is secured to a base plate 142 of the heat sink 140 by a plurality of fasteners 28 (one shown). It is envisioned that a thermal compound may be applied between the PCB 20 and the base plate 142 to enhance thermal conductivity therebetween. The PCB 20 includes LEDs 40 disposed therein or thereon and arranged in a pattern or array. The LEDs 40 are each in electrical communication with the first and second leads 134, 136 and are configured to generate light in response to energy provided by the driver 130 via the first and second leads 134, 136. It is envisioned that LEDs 40 are chosen at different color temperatures to provide a desired color of light. In embodiments, the LEDs 40 may be chosen to generate light of a desired output color or colors in a range of about 3500K to about 5000K. In some embodiments, the LEDs 40 may be chosen to generate light in an output color below 3500K or above 5000K. The PCB 20 may be configured with LEDs 40 configured to generate a total of about 18,000 lumens to about 24,000 lumens of light. Alternatively, the PCB 20 may include LEDs 40 configured to generate a total of less than 18,000 lumens or above 24,000 lumens.

As alluded to, connector assemblies 30, 32 are included, which connect the PCB 20 and the heat sink 140 via the first and second leads 134, 136. In this regard, the connector assemblies 30, 32 each include lead seals 148 and connectors 34, 36. The first and second leads 134, 136 pass through the base plate 142 and the PCB 20 and are each secured to the PCB 20 by respective first and second connectors 34, 36. The base plate 142 defines a first through hole 144 and a second through hole 146 that are respectively aligned with a first board hole 24 and a second board hole 26 defined in the PCB 20. A lead seal 148 is secured within a corresponding one of the first and second through holes 144, 146 and defines a passage 149 for receiving and sealing about an outer surface of a respective one of the first and second leads 134, 136. Each of the lead seals 148 may also form a seal with an upper surface of the PCB 20 about a respective one of the first and second board holes 24, 26. An exemplary lead seal is available from Delphi Automotive LLP under part number 15366021.

The first connector 34 is positioned over the first board hole 24 and receives an exposed end portion 135 of the first lead 134 to form an electrical connection between the first lead 134 and the PCB 20. The second connector 36 is positioned over the second board hole 26 and receives an exposed end portion 137 of the second lead 136 to form an electrical connection between the second lead 136 and the PCB 20.

Each of the first and second connectors 34, 36 allows a respective one of the first and second leads 134, 136 to pass through an opening 312 defined in a base 310 and to be captured between opposed legs 314. The opening 312 may be sized and dimensioned to allow an exposed end portion (e.g., first exposed end portion 135 or second exposed end 137) to pass through the base 310 while preventing the entire lead (e.g., first lead 134 or second lead 136) from passing through the base 310. The opposed legs 314 allow the respective exposed end portion 135, 137 to pass through in a first direction (e.g., down as shown in FIG. 2) and captures the respective exposed end portion 135, 137 to prevent the respective exposed end portion 135, 137 from withdrawing in a second direction (e.g., up as shown in FIG. 2) from between the opposed legs 314. Such a connector allows one of the first and second leads 134, 136 to be attached to the PCB 20 in a single “push-in” step without additional soldering to form an electrical connection between the driver 130 and the PCB 20. Examples of suitable connectors are available from AVX Corporation under part numbers 70-9296-001-103-006 and 70-9296-001-123-006.

Continuing to refer to FIGS. 1 and 2, the lens 50 is disposed over the PCB 20 and secured to the baseplate 142 with fasteners 58 (one shown). The lens 50 may form a seal with the baseplate 142 about the PCB 20 to seal or substantially seal the PCB 20 from the environment. It is contemplated that a gasket or seal (not explicitly shown) may be positioned between the baseplate 142 and the lens 50 to form a seal between the baseplate 142 and the lens 50.

The lens 50, the base plate 142, and the lead seals 148 may isolate the PCB 20 including the LEDs 40 within a cavity 52 defined between the lens 50 and the base plate 142. When isolated within the cavity 52, the PCB 20 and LEDs 40 are isolated from the environment surrounding the lighting fixture 100 while permitting energy to pass from the driver 130 to the LEDs 40. In addition, light generated by the LEDs 40 passes through the lens 50 and heat from the PCB 20, LEDs 40, lens 50, and reflector 150 passes through the base plate 142 and into the heat sink 140. Isolating the PCB 20 and the LEDs 40 may increase the service life of the PCB 20 and the LEDs 40. In addition, isolating the PCB 20 and the LEDs 40 may enhance the performance of the PCB 20 and the LEDs 40. It is contemplated that the cavity may be a vacuum or may include an gas, e.g., an inert gas, at a pressure greater than an environment surrounding the light generating assembly 10.

The reflector 150 is secured to the baseplate 142 with the lens 50 positioned within an opening 152 in the reflector 150. The lens 50 may direct light generated by the LEDs 40 into the reflector 150 such that light generated by the LEDs 40 is directed in a desired pattern. The lens 50 may also diffuse or filter light generated by the LEDs 40.

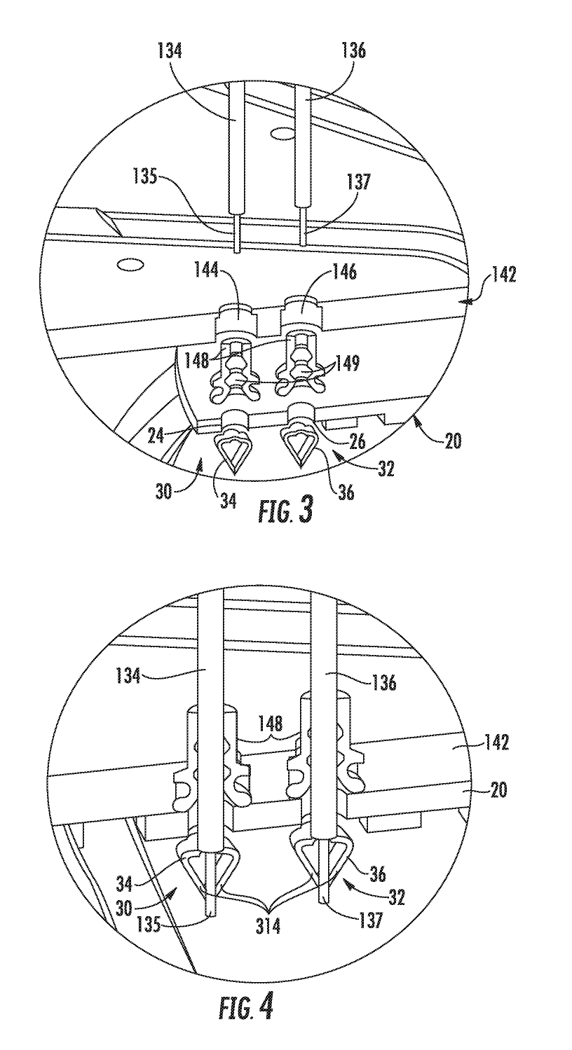

Referring to FIGS. 3 and 4, a method of assembling the light generating assembly 10 will be detailed in accordance with the present disclosure. Initially, the first and second leads 134, 136 have a portion of an insulator of the respective lead 134, 136 removed or striped to expose a conductor of the respective lead 134, 136 as an exposed end portion 135, 137, respectively. The exposed end portion 135 of the first lead 134 is then passed through the first through hole 144 in the base plate 142, a passage 149 of one of the lead seals 148, the first board hole 24 in the PCB 20, and between the legs 314 of the first connector 34. Similarly, the exposed end portion 137 of the second lead 136 is then passed through the second through hole 146 in the base plate 142, a passage 149 of the other the lead seal 148, the second board hole 26 in the PCB 20, and captured between the legs 314 of the second connector 36.

By permitting the first and second leads 134, 136 to pass through the base plate 142 and the PCB 20, the PCB 20 can be secured to the base plate 142 before or after the first and second leads 134, 136 are captured between the legs 314 of the first and second connectors 34, 36, respectively. In addition, the lens 150 can be secured to the base plate 142 before or after the first and second leads 134, 136 being captured in the first and second connectors 34, 36, respectively.

Alternatively, the exposed end portion 135 of the first lead 134 can be passed through the first board hole 24 in the PCB 20 and captured between the legs 314 of the first connector 34 and the exposed end portion 137 of the second lead 136 can be passed through the second board hole 26 in the PCB 20 and captured between the legs 134 of the second connector 36. After the exposed end portions 135, 137 are captured in respective connectors 34, 36, the other end of the leads 134, 136 are each passed through a passage 149 of a lead seal 148 that is positioned within one of the first or second through holes 144, 146 in the base plate 142. The PCB 20 can then be secured to the base plate 142 and the lens 150 can be secured to the base plate 142 over the PCB 20.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A lighting fixture comprising:
a driver;
a heat sink assembly coupled to the driver and including a base plate defining a first through hole;
a light generating assembly secured to the base plate, the light generating assembly including:
a PCB defining a first board hole therethrough;
a plurality of LEDs secured directly to the PCB; and
a board cover positioned over the PCB and fastened to the base plate;
a first connection assembly including a first connector secured directly to the PCB and in electrical communication with the plurality of LEDs; and
a first lead extending from the driver, through the first through hole, through the first board hole, and being captured by the first connector.

2. The lighting fixture according to claim 1, wherein the first connection assembly further includes a lead seal positioned within the first through hole forming a seal with an inner wall of the base plate defining the first through hole and an outer surface of the first lead.

3. The lighting fixture according to claim 2, wherein the lead seal forms a seal with a surface of the PCB.

4. The lighting fixture according to claim 1, wherein the first through hole is aligned with the first board hole.

5. The lighting fixture according to claim 1, wherein the board cover isolates the PCB from an environment surrounding the light generating assembly.

6. The lighting fixture according to claim 1, further comprising a top cover coupled to the heat sink.

7. The lighting fixture according to claim 6, further comprising a driver bracket directly secured to the top cover, the driver directly secured to the driver bracket.

8. The lighting fixture according to claim 6, wherein the top cover is configured to secure the lighting fixture to a mounting surface.

9. The lighting fixture according to claim 1, further comprising a reflector secured to the base plate.

10. The lighting fixture according to claim 9, wherein the light generating assembly is at least partially disposed within the reflector.

11. The lighting fixture according to claim 1, wherein the board cover is a lens.

12. The lighting fixture according to claim 1, wherein the board cover defines a cavity with the base plate.

13. The lighting fixture according to claim 12, wherein the cavity has pressure different from the pressure of the environment surrounding the light generating assembly.

14. The lighting fixture according to claim 1, further comprising:
a second lead; and
a second connection assembly including a second connector secured directly to the PCB and in electrical communication with the plurality of LEDs,
wherein:
the base plate defines a second through hole,
the PCB defines a second board hole therethrough,
the second lead extends from the driver, through the second through hole, and
through the second board hole, and
the second connector captures the second lead to electrically connect the second connector to the PCB.

15. A method of assembling a lighting fixture, the method comprising:
passing a first lead through a first board hole in a PCB such that an exposed end portion of the first lead is captured between opposed legs of a first connector secured to the PCB, the first connector in electrical communication with one or more LEDs of the PCB;
securing the PCB to a base plate of a heat sink assembly; and
securing a board cover to the base plate with the PCB disposed in a cavity defined between the board cover and the base plate.

16. The method according to claim 15, wherein securing the PCB to the base plate of the heat sink assembly occurs before passing the first lead through the first board hole in the PCB.

17. The method according to claim 16, wherein securing the board cover to the base plate occurs before passing the first lead through the first board hole in the PCB.

18. The method according to claim 16, wherein passing the first lead through the first board hole in the PCB includes passing the first lead through a first through hole defined in the base plate aligned with the first board hole.

19. The method according to claim 18, wherein passing the first lead through a first through hole defined in the base plate includes passing the first lead through a seal disposed within the first through hole to form a seal about an outer surface of the first lead.

20. The method according to claim 15, further comprising creating a pressure differential in the cavity relative to the environment outside of the cavity.
